(19) United States
(12) Patent Application Publication
(10) Pub. No.: US 2013/0328281 A1
(43) Pub. Date: Dec. 12, 2013

(54) Spring Bracket Arm Of A Spring Bracket Of A Motor Vehicle Axle

(71) Applicants: Paul Lenz, Waldkirchen (DE); Peter Haselberger, Mauth (DE)

(72) Inventors: Paul Lenz, Waldkirchen (DE); Peter Haselberger, Mauth (DE)

(21) Appl. No.: 14/000,986

(22) PCT Filed: Feb. 1, 2012
(86) PCT No.: PCT/EP2012/051621

§ 371 Date: Aug. 22, 2013

(30) Foreign Application Priority Data
Mar. 9, 2011 (DE) 102011005311.5

(51) Int. Cl. B60G 7/00

(52) U.S. Cl. CPC B60G 7/001
USPC 280/124.1

(57) ABSTRACT

A spring carrier arm of a spring carrier of a motor vehicle axle, particularly of a portal axle, has a longitudinal portion (1) extending in a curved manner, a transverse portion (2) adjoining the longitudinal portion (1) and extending transverse thereto, and a flange portion (3), particularly for connection to a wheel hub gear unit housing, wherein the transverse portion (2) includes at least one fastening point (4, 5) for connection to a shock absorber (18) and/or to a suspension. The spring carrier arm is generally formed as a cast part from a light metal alloy and has at least one ribbing. A motor vehicle axle in which aforementioned spring carrier arms are applied in the region of spring carriers are also disclosed.

### PRIORITY CLAIM

This is a U.S. national stage of application No. PCT/EP2012/051621, filed on Feb. 1, 1012. Priority is claimed on the following application(s): Country: Germany, Application No.: 10 2011 005 311.5, Filed: Mar. 9, 2011, the content of which is incorporated herein by reference.

### FIELD OF THE INVENTION

The invention is directed to a spring carrier arm of a spring carrier of a motor vehicle axle, particularly of a portal axle, having a longitudinal portion extending in a curved manner, a transverse portion adjoining the longitudinal portion and extending transverse thereto, and a flange portion, particularly for connection to a wheel hub gear unit housing, wherein the transverse portion includes at least one fastening point for connection to a shock absorber and/or to a suspension. The invention is further directed to a motor vehicle axle in which aforementioned spring carrier arms are provided in the region of spring carriers.

### BACKGROUND OF THE INVENTION

Spring carrier arms of spring carriers are used for motor vehicle axles to provide a connection of the respective motor vehicle axle to suspension elements and damping elements of the motor vehicle in question. Particularly in vehicle axles in busses, a spring carrier has two spring carrier arms by which a connection is made in front of and behind the wheels of the vehicle axle in longitudinal direction of the vehicle to the shock absorber and air springs positioned in those locations. The respective spring carrier can be composed of individual spring carrier arms which engage at an intermediate housing, for example, a wheel hub housing, or can also be constructed integrally. Further, constructions integral with the intermediate housing are also common.

Further, for low floor busses for urban driving, motor vehicle axles are commonly constructed as portal axles in which an axle differential is connected to wheel hub gear units installed in the wheel hubs. In so doing, the clearance of the vehicle axle and, therefore, also the clearance of the vehicle body with respect to the ground can be reduced by the wheel hub gear units which are constructed as reduction gear units. In this case, the respective spring carrier is also commonly fastened by its spring carrier arms to the respective wheel hub gear unit housing or is formed integral with the latter.

US2003137121 discloses a spring carrier of a portal axle. Formed of one or more parts, this spring carrier comprises two spring carrier arms. In this case, one spring carrier arm has a longitudinal portion which extends in a curved manner and which is adjoined by a transverse portion extending transverse thereto. Further, a flange portion is provided at an end of the longitudinal portion remote of the transverse portion, which flange portion affords a connection to a housing receiving the respective wheel hub gear unit of the wheel, or, in the region thereof, also in case of an integral construction of the spring carrier, forms a transition to the intermediate housing. To reduce the installation space for the spring carrier arms in particular, the longitudinal portion, transverse portion and flange portion of a spring carrier arm are each constructed as a solid body.

Proceeding from a spring carrier arm of the prior art, it is an object of the present invention to provide a spring carrier arm of a spring carrier of a motor vehicle axle which has reduced weight while retaining the same loading capacity.

### SUMMARY OF THE INVENTION

According to the invention, a spring carrier arm has a longitudinal portion extending in a curved manner, a transverse portion adjoining the longitudinal portion and extending transverse thereto, and a flange portion. The transverse portion has at least one fastening point for connection to a shock absorber and/or to a suspension. What is meant by the longitudinal portion extending in a curved manner is a curvature in direction of the transverse portion, but also an additional or alternative curvature in the transverse direction of the spring carrier arm orthogonal thereto. The transverse portion extending transverse to the longitudinal portion means that it extends chiefly orthogonal to the longitudinal direction of the spring carrier arm. The at least one fastening point of the transverse portion is preferably a bore hole for a screwed connection to the shock absorber and/or suspension. The shock absorber and suspension can be connected as combined assembly with only one fastening point, but can also be coupled as separate structural component parts respectively with an associated fastening point at the transverse portion. By shock absorber is meant particularly a hydraulic shock absorber. Within the meaning of the invention, a suspension can be a pneumatic suspension of the motor vehicle.

The invention encompasses the teaching that the spring carrier arm is generally formed as a cast part from a light metal alloy and has at least one ribbing. A spring carrier arm constructed in this way has the advantage that the weight can be substantially reduced through the use of a light metal alloy, but the loading capacity of an iron casting variant can be achieved by providing a corresponding ribbing. Further, by using a light metal alloy, a faster machining of the respective spring carrier arm can also usually be achieved due to the possibility of higher cutting speeds. In particular, EN AC-AlSi7MgO,3ST6 or a comparable material can be used.

In further development of the invention, the longitudinal portion is provided with a stiffening rib on a lateral surface remote of the transverse portion. By providing a rib in this area, the vibration behavior of the spring carrier arm can be improved in particular.

According to a further advantageous embodiment of the invention, a rib extending between the flange portion and the at least one fastening point along the longitudinal portion is provided on an underside, this rib being formed in the manner of a hump at least in a region of the longitudinal portion. The transverse portion advantageously has a first fastening point and a second fastening point, and the rib extends from the flange portion over the first fastening point to the second fastening point. This embodiment has the general advantage that the geometric layout can be configured so as to be optimized with respect to tension as regards the flow of force and structural component parts by means of this rib which is subject to tensile stress under load. Consequently, it is possible to have sufficient loading capacity in spite of the lower strength of the light metal alloy in a construction which economizes on material at the same time.

In further development of the invention, the flange portion and, at least in some areas, the longitudinal portion are constructed so as to be hollow. As a result of the partially hollow construction, economy can be exercised with respect to material and production cost and weight can be further reduced. In so doing, by moving the cavity into the region of the flange portion and the adjoining region of the longitudinal portion, it is possible to cast the spring carrier arm substantially without use of a core. The cavity can be formed during the casting process by an outside core supported at one side or by a slide so that the manufacturing process is correspondingly simplified. The geometric configuration of the spring carrier arm according to the invention is generally suitable for sand casting or permanent mold casting.

According to a further embodiment of the invention, with the exception of connection surfaces of the flange portion and of the at least one fastening point, exclusively sloping surfaces are provided. In this way, a corrosion-reducing design of structural component parts can be achieved because liquids which reach the spring carrier arm during operation of the motor vehicle flow away due to gravity as a result of the sloping surfaces. To further reduce corrosion of the spring carrier arm, it is possible within the scope of the invention to perform surface treatment by blast cleaning with nonmetallic blasting material.

According to a further advantageous embodiment of the invention, connection surfaces of the flange portion and/or of the at least one fastening point are provided with a separating device. By providing a suitable separating device in these areas, immediate contact between the spring carrier arm and the adjoining structural component part can be prevented and contact corrosion between the two members to be connected can be extensively eliminated. Common surface separating means can be employed for this purpose.

In further development of the invention, the at least one fastening point has a connection element formed of elastomeric bodies which are positioned above and below the transverse portion and are arranged in each instance with a through-hole coaxial to a bore hole of the at least one fastening point and, in so doing, engage in the bore hole by an axial protrusion. This advantageously prevents contact corrosion between the spring carrier arm and the structural component part, particularly a shock absorber, connected therewith in this region in that only an indirect connection is produced between the spring carrier arm and the respective structural component part by the connection element which is accordingly constructed in the manner of an elastomeric joint. Direct contact with an element of the adjoining structural component part guided through the bore hole of the fastening point is prevented by the axial protrusion.

In further development of the invention, connection surfaces of the at least one fastening point and of the flange portion are fully cast or are machined. By means of this step, a sufficient surface condition for the connection is guaranteed in these regions, but production costs are kept low at the same time because of the cast surface that remains otherwise untreated.

In the cases mentioned above, connection surfaces of the flange portion and of the at least one fastening point are understood to be surfaces which, when the spring carrier arm is connected to adjoining structural component parts, come into contact with the adjoining structural component parts or with connection devices used for the latter. As regards the flange portion, this refers particularly to screw-on points for fastening to an adjoining housing with corresponding screw head locating surfaces or also to join surfaces for bonding connection, for example, welding, to the adjoining structural component part. By connection surfaces of the at least one fastening point are meant surfaces at which the transverse portion makes contact with an adjoining structural component part and/or by which it is connected to the adjoining structural component part.

The invention is not limited to the indicated combination of features of the main claim or of the dependent claims. Moreover, it is possible to combine individual features also insofar as they follow from the claims, the following description of the embodiment form or directly from the drawings. The protective scope of the claims is not limited by reference in the claims to the drawings through the use of reference numerals.

### BRIEF DESCRIPTION OF THE DRAWINGS

Further features improving the invention are indicated in greater detail in the following along with the description of a preferred embodiment of the invention referring to the drawings in which:

FIG. 1 is a perspective view of a preferred embodiment of the spring carrier arm according to the invention;

FIG. 2 is another perspective view of the spring carrier arm according to the invention from FIG. 1;

FIG. 3 is a side view of the spring carrier arm according to the invention from FIG. 1; and

FIG. 4 is a sectional view in the region of a fastening point and a connection element of the spring carrier arm according to the invention.

### DETAILED DESCRIPTION OF THE PRESENTLY PREFERRED EMBODIMENTS

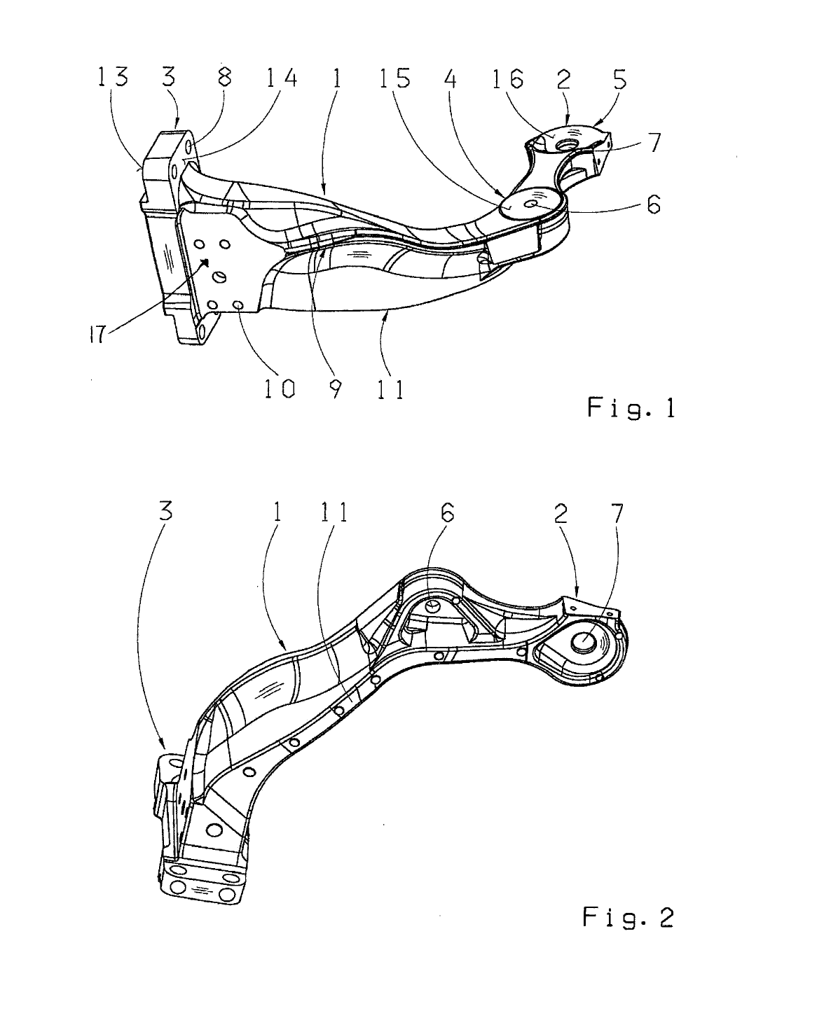

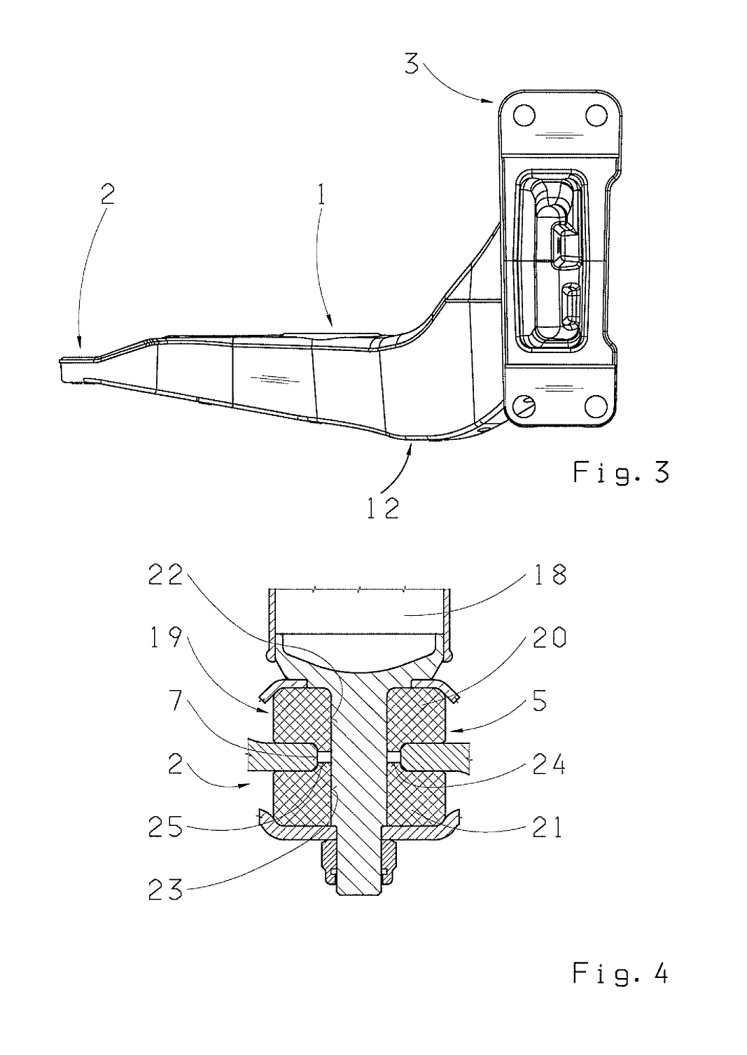

FIG. 1 shows a perspective view of a preferred embodiment of the spring carrier arm according to the invention. This spring carrier arm is formed in one piece as a casting from EN-AC-AlSi7MgO,3ST6 and has a longitudinal portion 1, a transverse portion 2 extending transverse to the longitudinal portion 1, and a flange portion 3 which is provided at an end of the longitudinal portion 1 remote of the transverse portion 2. As will be seen from the other perspective view in FIG. 2 in conjunction with the side view in FIG. 3, the longitudinal portion 1 has a curvature which is oriented in direction of the transverse portion 2 and in transverse direction orthogonal thereto. In so doing, an extension of the longitudinal portion in transverse direction starting from the flange portion 3 in direction of the transverse portion 2 decreases to a degree corresponding to the extension of the transverse portion in this direction. Further, the spring carrier arm is formed in the region of the flange portion 3 and along part of the longitudinal portion 1 as a hollow body.

As can further be seen from FIG. 1 as well as from FIG. 2, the transverse portion 2 has a first fastening point 4 and a second fastening point 5 by which the spring carrier arm according to the invention can be connected to a shock absorber and to a pneumatic suspension of a motor vehicle via correspondingly furnished bore holes 6 and 7. In this regard, in the installed condition of the spring carrier arm according to the invention in the region of a motor vehicle axle a connection to a pneumatic suspension is made by the first fastening point 4 and a connection to a shock absorber of the motor vehicle is made by the second fastening point 5. Further, screw-on points 8 are provided at the flange portion 3 by which the spring carrier arm according to the invention can be connected in particular to a wheel hub gear unit housing of a portal axle of the motor vehicle.

It can be seen from FIG. 1 that the longitudinal portion 1 has a stiffening rib 9 which is oriented opposite to the transverse portion 2 and which is formed on a lateral surface of the longitudinal portion 1. The vibration behavior of the spring carrier arm in particular can be improved by this stiffening rib 9. Further, there are provided in the region of this lateral surface screw-on points 10 by which a connection can be made to a stabilizer of the motor vehicle.

Further, the spring carrier arm according to the invention has a rib 11 which, as can be seen particularly from FIG. 2, extends on an underside from the flange portion 3 along the longitudinal portion 1 and first fastening point 4 to the second fastening point 5. This rib 11 forms a hump 12 in the region of the longitudinal portion 1 as can be seen from FIG. 3. A tension-optimized geometry of the spring carrier arm according to the invention can be achieved by the rib 11 so that material can be spared in the connecting area from flange portion 3 to transverse portion 2.

Further, connection surfaces 13 and 14 in the region of the flange portion 3 are machined and connection points 15 and 16 of the fastening points 4 and 5 are fully cast. After the spring carrier arm is cast, a connection surface 17 in the lateral region of the longitudinal portion 1 that is provided for connecting to the stabilizer of the motor vehicle is also machined. In this way, a sufficient surface condition is achieved for the individual connection surfaces 13 to 17 to ensure optimal contact of the adjoining structural component part or optimal seating of connection elements such as screws. Further, production costs can be kept low in that the above-mentioned surfaces need only be partially machined. Further, with the exception of connection surfaces 13 to 17, the surfaces of the spring carrier arm are constructed in a sloping manner so that no liquid can collect in these areas and cause corresponding corrosion.

As a further feature, the flange portion 3 is provided in the region of connection surfaces 13 and of first fastening point 4 in the region of connection surfaces 15 with a separating device, not shown here in more detail, which prevent direct contact between the spring carrier arm and the structural component part adjoining it in the installed state. Accordingly, contact corrosion can be prevented from occurring in these areas.

Finally, FIG. 4 shows a sectional view in the region of the second fastening point 5 of the transverse portion 2. A connection element 19 comprising two elastomeric bodies 20 and 21 is provided in the region of the second fastening point 5 for connecting the spring carrier arm according to the invention to a shock absorber 18 which is not shown in greater detail. These elastomeric bodies 20 and 21 each have a through-hole 22 and 23, respectively, by which they are each positioned coaxial to the bore hole 7 of the second fastening point 5. Further, axial protrusions 24 and 25 by which the elastomeric bodies 20 and 21 engage in the bore hole 7 in axial direction are formed at the elastomeric bodies 20 and 21. As a result of this construction, the spring carrier arm is connected to the shock absorber 18 only indirectly by the intermediate elastomeric bodies 20 and 21 so that no contact, and therefore also no contact corrosion, can occur between the two connecting members.

An appreciable reduction in weight can be achieved by the construction of a spring carrier arm according to the invention while simultaneously retaining the same stiffness characteristics. Further, the spring carrier arm according to the invention is characterized by low production costs due to the design of the respective connection surfaces. Further, the risk of corrosion is also circumvented by the surface configuration and configuration of the connection surfaces.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A spring carrier arm of a spring carrier of a motor vehicle axle, preferably of a portal axle comprising:
a longitudinal portion (1) extending in a curved manner;
a transverse portion (2) adjoining the longitudinal portion (1) and extending transverse thereto;
a flange portion (3) for connection to a wheel hub gear unit housing;
the transverse portion (2) comprising at least one fastening point (4, 5) for connection to one of a shock absorber (18) and to a suspension; and wherein the spring carrier arm is generally formed as a cast part from a light metal alloy and comprises at least one ribbing.

12. The spring carrier arm according to claim 11, wherein the longitudinal portion (1) comprises a stiffening rib (9) on a lateral surface remote of the transverse portion (2).

13. The spring carrier arm according to claim 11, further comprising a rib (11) extending between the flange portion (3) and the at least one fastening point (4, 5) along the longitudinal portion (1) on an underside, the rib (11) being formed as a hump at least in a region of the longitudinal portion (1).

14. The spring carrier arm according to claim 13, wherein the transverse portion (2) comprises a first fastening point (4) and a second fastening point (5), and wherein the rib (11) extends from the flange portion (3) over the first fastening point (4) to the second fastening point (5).

15. The spring carrier arm according to claim 11, wherein the flange portion (3) and the longitudinal portion (1) are, at least in some areas adjoining the flange portion constructed so as to be hollow.

16. The spring carrier arm according to claim 11, wherein, with the exception of connection surfaces (13, 14, 15, 16, 17) of the flange portion (3) and of the at least one fastening point (4, 5), all surfaces are exclusively sloping surfaces.

17. The spring carrier arm according to claim 11, wherein the at least one fastening point (5) comprises a connection element (19) formed of elastomeric bodies (20, 21) positioned above and below the transverse portion (2), each elastomeric body comprising an axial protrusion (25, 25) and a through-hole (22, 23) coaxial to a bore hole (7) of the at least one fastening point (5) so as to engage in the bore hole (7) with the axial protrusion (24, 25).

18. The spring carrier arm according to claim 11, wherein the connection surfaces (13, 14, 15, 16, 17) of the at least one fastening point (4, 5) and of the flange portion (3) are fully cast or are machined.

19. A motor vehicle axle for connecting wheel carriers to a vehicle body, comprising a spring carrier formed with a spring carrier arm according to claim 1.
